(19) United States
(12) Patent Application Publication
(10) Pub. No.: US 2009/0059055 A1
(43) Pub. Date: Mar. 5, 2009

(54) OPTICAL DEVICE AND METHOD FOR FABRICATING THE SAME

(76) Inventors: Takahiro Nakano, Kyoto (JP); Yoshihiro Tomita, Osaka (JP); Hikari Sano, Hyogo (JP)

Correspondence Address: MCDERMOTT WILL & EMERY LLP, 600 13TH STREET, NW, WASHINGTON, DC, 20005-3096, US

(21) Appl. No.: 12/195,081

(22) Filed: Aug. 20, 2008

(30) Foreign Application Priority Data
Sep. 4, 2007 (JP) 2007-229429

(51) Int. Cl. H04N 5/225

(52) U.S. Cl. 348/340; 348/E05.024

(57) ABSTRACT

An optical device includes: an optical element including an imaging region, a peripheral circuit region formed at the rim of the imaging region and including a plurality of electrode portions, and a plurality of microlenses formed on the imaging region; a plurality of through-hole electrodes connected to the respective electrode portions and formed through the semiconductor substrate along the thickness of the semiconductor substrate; a plurality of metal interconnects connected to the respective through-hole electrodes and formed on a back surface of the semiconductor substrate opposite to a principal surface of the semiconductor substrate; an adhesive member formed on a surface of the optical element and made of a resin; and a transparent board bonded to the optical element with the adhesive member interposed therebetween. The transparent board has a planar shape larger than that of the optical element.

### BACKGROUND OF THE INVENTION

The present invention relates to optical devices and methods for fabricating the devices.

A solid-state imaging device, serving as a major device among optical devices, is provided with a large number of optical elements including imaging regions and microlenses on a semiconductor wafer, is hermetically molded after formation of electrical interconnection, and is used as a light-receiving sensor of digital video equipment such as a digital still camera, a camera for a cellular phone and a digital video camera. To achieve miniaturization, thickness reduction and higher packaging density for recent video equipment, not a previous ceramic or plastic package in which electrical connection is established by die-bonding and wire-bonding but a wafer-level chip size package (CSP) in which electrical connection is established by forming through-hole electrodes and rewiring during assembly in wafer form, comes to be employed as a structure of solid-state imaging devices.

FIG. 9 is a cross-sectional view illustrating a conventional solid-state imaging device having a wafer level CSP structure.

As illustrated in FIG. 9, a conventional solid-state imaging device 100A is provided with a solid-state imaging element 100 including: an imaging region 102 formed in a semiconductor substrate 101 and having a surface on which a plurality of microlenses 103 are placed; a peripheral circuit region 104a formed at the rim of the imaging region 102 in the semiconductor substrate 101; and a plurality of electrode portions 104b formed in the peripheral circuit region 104a. A transparent board 106 made of, for example, optical glass is formed at the principal surface of the solid-state imaging element 100 with an adhesive member 105 of a resin layer interposed therebetween. Metal interconnects 108 connected to the electrode portions 104b of the peripheral circuit region 104a via through-hole electrodes 107 penetrating the semiconductor substrate 101 along the thickness is formed at the back surface (i.e., the surface opposite to the principal surface) of the solid-state imaging element 100. The metal interconnects 108 are covered with an insulating resin layer 109 having openings 110 in which the metal interconnects 108 are partly exposed. External electrodes 111 made of, for example, a solder material are formed in the respective openings 110. The solid-state imaging element 100 is electrically insulated from the through-hole electrodes 107 and the metal interconnects 108 by an insulating layer which is not shown.

As described above, in the solid-state imaging device 100A, the electrode portions 104b are electrically connected to the metal interconnects 108 via the through-hole electrodes 107 and are also electrically connected to the external electrodes 111 via the metal interconnects 108, thereby allowing a received light signal to be output.

FIGS. 10A through 10C and FIGS. 11A and 11B are cross-sectional views showing a method for fabricating the conventional solid-state imaging device in the order of fabrication steps.

First, as shown in FIG. 10A, a wafer which is provided with a plurality of solid-state imaging elements 100 with the above-described structure and is formed in a known method is prepared. Then, a transparent board 106 which has the same diameter as the wafer, is in wafer form and made of, for example, optical glass is attached to the wafer with an adhesive member 105 of a resin layer is interposed therebetween.

Next, as shown in FIG. 10B, through holes in which electrode portions 104b of the peripheral circuit region 104a are exposed are formed through the semiconductor substrate 101 from the back surface thereof by for example, dry etching or wet etching, and then are filled with a conductive film, thereby forming through-hole electrodes 107 connected to the electrode portions 104b for outputting a received light signal.

Then, as shown in FIG. 10C, metal interconnects 108 electrically connected to the through-hole electrodes 107 are formed by electroplating on the back surfaces of the solid-state imaging elements 100.

Thereafter, as shown in FIG. 11A, an insulating resin layer 109 is formed to cover the metal interconnects 108 over the back surfaces of the solid-state imaging elements 100. The insulating resin layer 109 is generally made of a photosensitive resin and formed by spin coating or attaching a dry film. Subsequently, the insulating resin layer 109 is selectively removed with a photolithography technique (exposure to light and development), thereby forming openings 110 in which the metal interconnects 108 are partly exposed. Thereafter, external electrodes 111 made of, for example, a solder material and electrically connected to the metal interconnects 108 are formed in the openings 110 with a solder ball mounting process using flux or a solder paste printing process.

Lastly, as shown in FIG. 11B, the solid-state imaging elements 100, the adhesive member 105, the transparent board 106 and the insulating resin layer 109 are cut at a time with a cutting member 112 such as a dicing saw to be formed into individual solid-state imaging devices 100A shown in FIG. 9. At this time, the solid-state imaging elements 100 and the transparent board 106 have an identical planar shape. To reduce cutting damage from separating those components into individual pieces at a time, separation into the pieces may be achieved through two steps, i.e., the solid-state imaging elements 100 and the transparent board 106 may be individually cut through two respective steps. In this case, with respect to cutting members 112 such as a dicing saw used for forming the individual pieces, a cutting member 112 used for cutting the transparent board 106 is wider than a cutting member 112 used for cutting the solid-state imaging elements 100. Thus, the planar shape of the resultant solid-state imaging elements 100 is larger than that of the resultant pieces of the transparent board 106. See, for example, Japanese Unexamined Patent Publications Nos. 2004-207461 and 2007-123909 for the foregoing description.

In the conventional solid-state imaging device, however, the planar shape of the transparent board (e.g., optical glass) is equal to or smaller than that of the solid-state imaging element, so that the imaging region and the side face of the transparent board are closely located. Therefore, incident light from the side face of the transparent board and irregular reflection at an end (a corner) of the transparent board cause image properties to deteriorate.

In particular, when the solid-state imaging elements and the transparent board are cut into individual pieces at a time, cutting damage increases surface roughness and causes defects such as scratches and cracks at the side face of the transparent board, resulting in further deterioration of image properties. Therefore, a surface process needs to be performed on the side face of the transparent board depending on the types of the image deterioration. The cutting damage also causes the problems of lower adhesion and peeling off of the adhesive member of a resin layer bonding the solid-state imaging elements and the transparent board together.

As described above, a cutting member for cutting the transparent board is wider than a cutting member for cutting the solid-state imaging elements. Therefore, if the solid-state imaging elements and the transparent board are cut into individual pieces at a time, not the cutting member for cutting the solid-state imaging elements but the cutting member for cutting the transparent board should be used as the cutting member such as a dicing saw. In addition, such separation into individual pieces involves the problem of an extremely short life of the cutting member such as a dicing saw.

Moreover, since the planar shape of the resultant transparent board is equal to or smaller than that of each of the solid-state imaging elements, the contact area between the transparent board and the adhesive member is equal to or smaller than that between each of the solid-state imaging elements and the adhesive member. Accordingly, when thermal stress or external stress is repeatedly applied to the solid-state imaging device, such stress is likely to be concentrated on the electrode portions of the peripheral circuit region so that the electrode portions are very likely to be peeled off or broken.

In the fabrication method, the transparent board in wafer form is bonded to the wafer including the solid-state imaging elements with the adhesive member interposed therebetween immediately after fabrication starts. Thus, the adhesive member needs to have a high heat resistance and a high solvent resistance in subsequent processes (such as photolithography, etching, and plating). In addition, the side face of the adhesive member is exposed directly to the outside air. Thus, the adhesive member also needs to have high resistances (such as high heat resistance and high moisture resistance) in an environment in which the solid-state imaging device is used.

### SUMMARY OF THE INVENTION

It is therefore an object of the present invention to provide a low-cost solid-state imaging device with excellent image properties and a method for fabricating the solid-state imaging device.

To achieve the object, an optical device according to the present invention includes: an optical element including an imaging region formed on a principal surface of a semiconductor substrate, a peripheral circuit region formed at a rim of the imaging region and including a plurality of electrode portions, and a plurality of microlenses formed on the imaging region; a plurality of through-hole electrodes connected to the respective electrode portions and formed through the semiconductor substrate along the thickness of the semiconductor substrate; a plurality of metal interconnects connected to the respective through-hole electrodes and formed on a back surface of the semiconductor substrate opposite to the principal surface of the semiconductor substrate; an adhesive member formed on a surface of the optical element and made of a resin; and a transparent board bonded to the optical element with the adhesive member interposed therebetween, wherein the transparent board has a planar shape larger than that of the optical element.

In an aspect of the present invention, the optical device further includes a resin layer covering a side face of the adhesive member.

In another aspect of the present invention, in the optical device, the adhesive member is formed over the entire surface of the optical device.

In yet another aspect of the present invention, in the optical device, the adhesive member is selectively formed only on a region of the surface of the optical element where the microlenses are formed.

In still another aspect of the present invention, in the optical device, a contact area between the transparent board and the adhesive member is larger than a contact area between the surface of the optical element and the adhesive member.

In still another aspect of the present invention, in the optical device, the adhesive member has a thickness of 50 μm or less.

In still another aspect of the present invention, the optical device further includes: an insulating resin layer formed on a back surface of the optical element to cover the metal interconnects and having openings in which the metal interconnects are partly exposed; and external electrodes formed in the respective openings and connected to the metal interconnects.

A first method for fabricating optical devices according to the present invention includes the steps of: preparing an assembly provided with a plurality of optical elements, each of the optical elements including an imaging region formed on a principal surface of a semiconductor substrate, a peripheral circuit region formed at a rim of the imaging region and including a plurality of electrode portions, and a plurality of microlenses formed on the imaging region; forming a plurality of through-hole electrodes connected to the respective electrode portions and formed through the semiconductor substrate along the thickness of the semiconductor substrate; forming a plurality of metal interconnects in contact with the respective through-hole electrodes and formed on a back surface of the semiconductor substrate opposite to the principal surface of the semiconductor substrate; cutting the assembly into a plurality of pieces corresponding to the respective optical elements, after the step of forming the metal interconnects; bonding a surface of each of the optical elements and the transparent board together with an adhesive member of a resin interposed therebetween in such a manner that the resultant optical elements are spaced apart from each other; and separating the transparent board into pieces along the space between the optical elements.

In an aspect of the present invention, the first method further includes the step of forming a resin layer in the space between the optical elements on the transparent board, after the step of bonding the surface of each of the optical elements and the transparent board together, wherein in the step of separating the transparent board, the resin layer and the transparent board are formed into pieces along the space between the optical elements.

A second method for fabricating optical devices according to the present invention includes the steps of: preparing an assembly provided with a plurality of optical elements, each of the optical elements including an imaging region formed on a principal surface of a semiconductor substrate, a peripheral circuit region formed at a rim of the imaging region and including a plurality of electrode portions, and a plurality of microlenses formed on the imaging region; forming a plurality of through-hole electrodes connected to the respective electrode portions and formed through the semiconductor substrate along the thickness of the semiconductor substrate; forming a plurality of metal interconnects in contact with the respective through-hole electrodes and formed on a back surface of the semiconductor substrate opposite to the principal surface of the semiconductor substrate; cutting the assembly into a plurality of pieces corresponding to the respective optical elements, after the step of forming the metal interconnects; forming a resin layer on the transparent board, the resin layer selectively having a plurality of openings; bonding a surface of each of the optical elements and the transparent board together with an adhesive member of a resin interposed therebetween in such a manner that the resultant optical elements are spaced apart from each other; and separating the resin layer and the transparent board into pieces along the space between the optical elements.

In an aspect of the present invention, in the first or second method, in the step of separating the transparent board, the transparent board has a planar shape larger than that of each of the optical elements.

In another aspect of the present invention, in the first or second method, the adhesive member is formed over the entire surfaces of the optical elements.

In yet another aspect of the present invention, in the first or second method, the adhesive member is selectively formed only on a region of the surface of each of the optical elements except for a region where the microlenses are formed.

In still another aspect of the present invention, in the first or second method, a contact area between the transparent board and the adhesive member is larger than a contact area between the surface of each of the optical elements and the adhesive member.

In still another aspect of the present invention, in the first or second method, the adhesive member has a thickness of 50 μm or less.

In still another aspect of the present invention, the first or second method further includes the steps of: forming an insulating resin layer on back surfaces of the optical elements, the insulating resin layer covering the metal interconnects and having openings in which the metal interconnects are partly exposed; and forming external electrodes in the respective openings, the external electrodes being connected to the metal interconnects, wherein the step of forming the insulating resin layer and the step of forming the external electrodes are performed after the step of forming the metal interconnects.

As described above, according to the present invention, deterioration of image properties caused by incident light from the side face of the transparent board and the irregular reflection at an end (a corner) of the transparent board is suppressed. It is also possible to suppress deterioration of image properties caused by increased surface roughness and defects such as scratching and chipping at the side face of the transparent board due to cutting damage in separating the transparent board into individual pieces. Therefore, no surface processes are necessary for the side faces of the individual pieces of the transparent board, thus making it possible to reduce the cost. In addition, the adhesive member does not need to have high resistances, thus also achieving cost reduction.

### BRIEF DESCRIPTION OF THE DRAWINGS

FIGS. 1A and 1B are cross-sectional views each illustrating a structure of a solid-state imaging device according to a first embodiment of the present invention.

FIG. 2 is a cross-sectional view illustrating a structure of a solid-state imaging device according to a second embodiment of the present invention.

FIGS. 3A through 3E are cross-sectional views showing a method for fabricating a solid-state imaging device according to a third embodiment of the present invention.

FIGS. 4A and 4B are cross-sectional views showing the method for fabricating a solid-state imaging device according to the third embodiment.

FIG. 5 is a cross-sectional view illustrating a structure of a solid-state imaging device according to a fourth embodiment of the present invention.

FIGS. 6A through 6C are cross-sectional views showing a method for fabricating a solid-state imaging device according to a fifth embodiment of the present invention.

FIG. 7 is a cross-sectional view illustrating a structure of a solid-state imaging device according to a sixth embodiment of the present invention.

FIGS. 8A through 8D are cross-sectional views showing a method for fabricating a solid-state imaging device according to a seventh embodiment of the present invention.

FIG. 9 is a cross-sectional view illustrating a structure of a conventional solid-state imaging device.

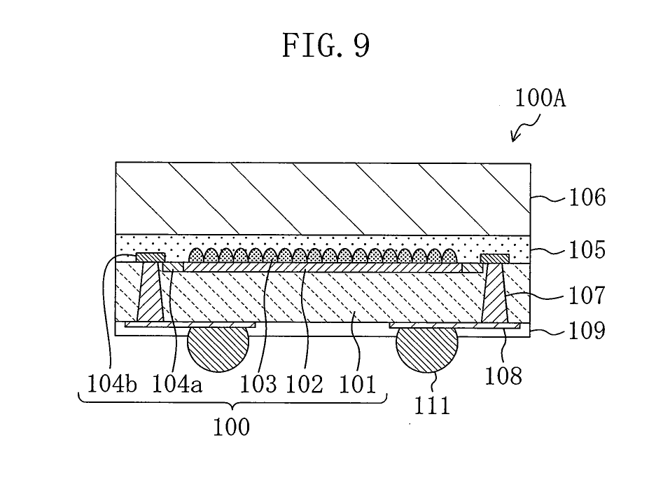

FIGS. 10A through 10C are cross-sectional views showing a conventional method for fabricating a solid-state imaging device in the order of fabrication steps.

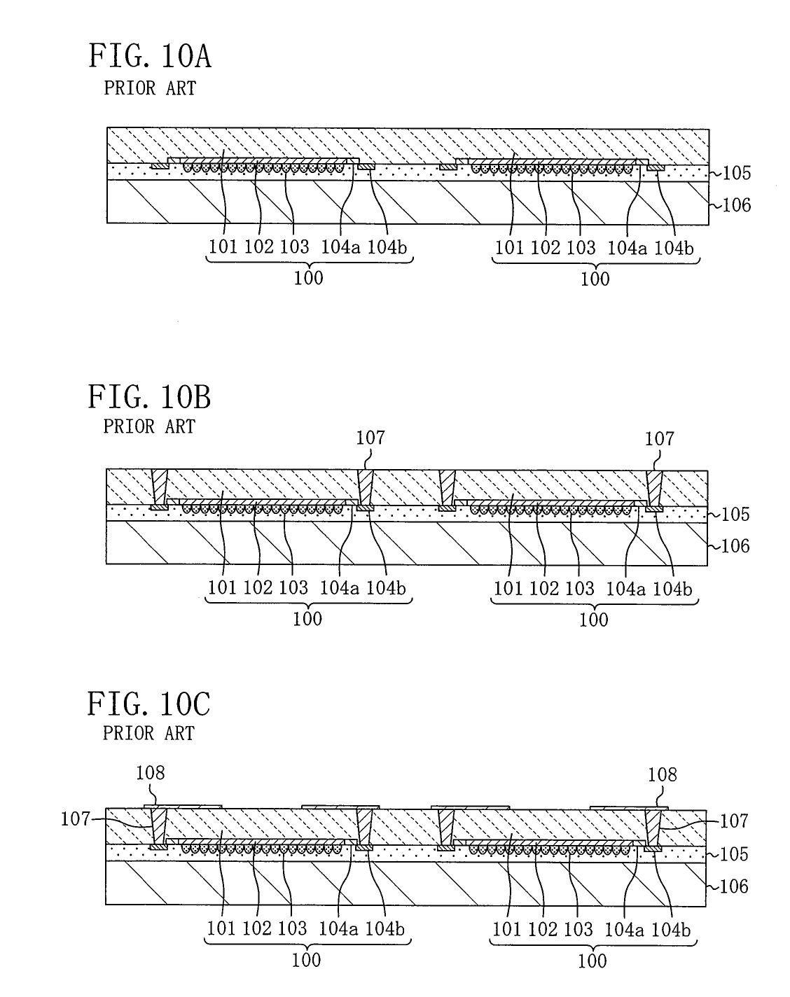

FIGS. 11A and 11B are cross-sectional views showing the conventional method for fabricating a solid-state imaging device in the order of fabrication steps.

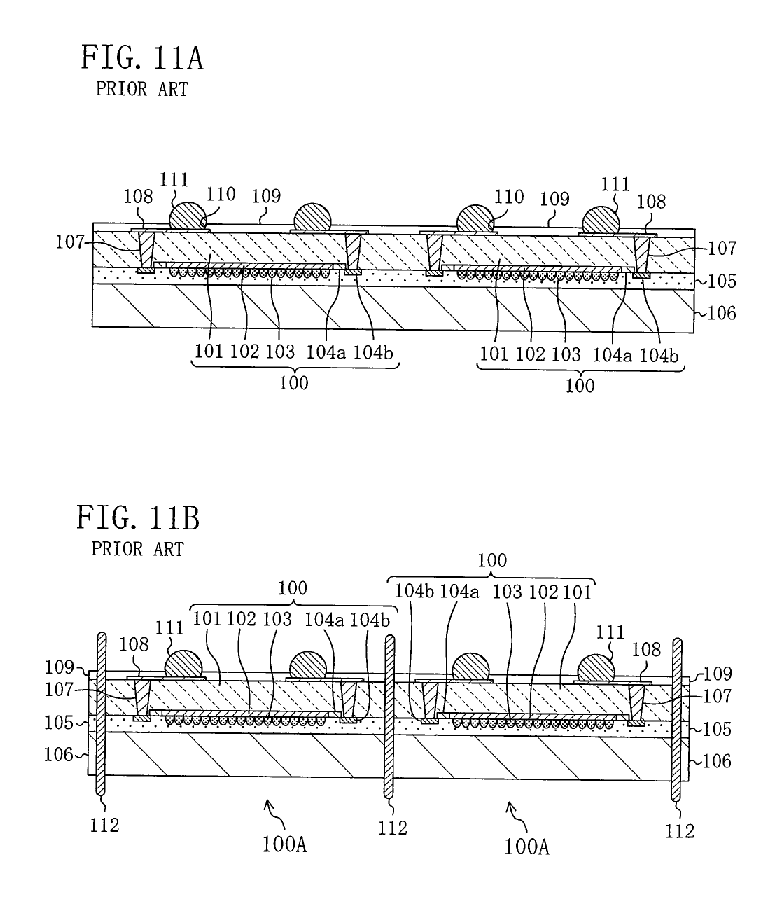

### DETAILED DESCRIPTION OF THE INVENTION

### Embodiment 1

Hereinafter, a solid-state imaging device according to a first embodiment of the present invention will be described.

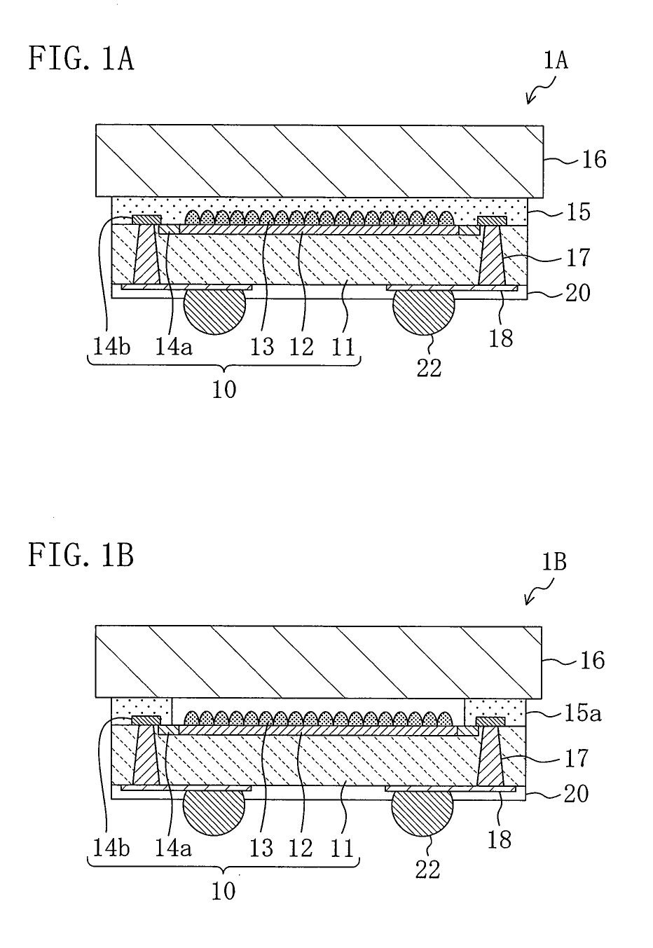

FIGS. 1A and 1B are cross-sectional views each illustrating a structure of the solid-state imaging device of the first embodiment.

First, as illustrated in FIG. 1A, the solid-state imaging device 1A of the first embodiment is provided with a solid-state imaging element 10 including: an imaging region 12 formed in a semiconductor substrate 11 and having a surface on which a plurality of microlenses 13 are placed; a peripheral circuit region 14a formed at the rim of the imaging region 12 in the semiconductor substrate 11; and a plurality of electrode portions 14b formed in the peripheral circuit region 14a. A transparent board 16 made of, for example, optical glass is attached to the principal surface of the solid-state imaging element 10 with an adhesive member 15 of a resin layer interposed therebetween. The transparent board 16 is larger than the solid-state imaging element 10. Specifically, as shown in the drawing, the planar shape (i.e., the shape in plan view) of the transparent board 16 is larger than that of the solid-state imaging element 10. The area of the planar shape of the transparent board 16 with respect to that of the solid-state imaging element 10 only needs to be determined according to application of the device in consideration of ensuring of image properties and a relationship of packaging areas.

The adhesive member 15 may be formed over the entire surface of the solid-state imaging element 10 including the microlenses 13 provided on the imaging region 12 as in the solid-state imaging device 1A illustrated in FIG. 1A. Alternatively, the adhesive member 15 may be formed over a region except for the imaging region 12 as in the solid-state imaging device 1B illustrated in FIG. 1B. That is, an adhesive member 15a having a cavity between the imaging region 12 and the transparent board 16 may be used. The structure of the adhesive member 15 or 15b may be appropriately selected depending on electrical characteristics and image performance of the solid-state imaging element 10 and structures and materials of the imaging region 12 and the microlenses 13.

Metal interconnects 18 made of, for example, copper are formed at the back surface (i.e., the surface opposite to the principal surface) of the solid-state imaging element 10 and are connected to the electrode portions 14b via through-hole electrodes 17 (having a depth of, for example, 100 nm to 300 nm) penetrating the semiconductor substrate 11 along the thickness. The metal interconnects 18 are covered with an insulating resin layer 20 having openings in which the metal interconnects 18 are partly exposed. External electrodes 22 made of, for example, a lead-free solder material with a Sn—Ag—Cu composition are formed in the openings of the insulating resin layer 20. The solid-state imaging element 10 is electrically insulated from the through-hole electrodes 17 and the metal interconnects 18 by an insulating layer which is not shown.

The microlenses 13 may be made of an organic material such as a resin or an inorganic material, and is preferably made of a material with a refractive index as high as possible in order to enhance a light-focusing effect. The adhesive member 15 is preferably made of a general thermosetting or UV-curing resin and is also preferably made of a material having a refractive index lower than that of the optically-transparent microlenses 13. The transparent board 16 is preferably made of optically-transparent glass.

In this manner, the electrode portions 14b are electrically connected to the metal interconnects 18 via the through-hole electrodes 17 and are also electrically connected to the external electrodes 22 via the metal interconnects 18. This enables a received light signal to be output in the solid-state imaging device 1A of this embodiment.

As described above, in the solid-state imaging device 1A of this embodiment illustrated in FIG. 1A, the transparent board 16 is larger than the solid-state imaging element 10 so that the distance from the imaging region 12 to the side face of the transparent board 16 is increased, thus suppressing deterioration of image properties caused by incident light from the side face of the transparent board 16 and the irregular reflection at an end (a corner) of the transparent board 16. It is also possible to suppress deterioration of image properties caused by increased surface roughness and defects such as scratching and chipping at the side face of the transparent board 16 due to cutting damage in separating the transparent board 16 into individual pieces. Accordingly, no surface processes are necessary for the side faces of the individual pieces of the transparent board 16, thus making it possible to reduce the cost. The same advantages as those described above are obtained for the solid-state imaging device 1B illustrated in FIG. 1B.

### Embodiment 2

Hereinafter, a solid-state imaging device according to a second embodiment of the present invention will be described.

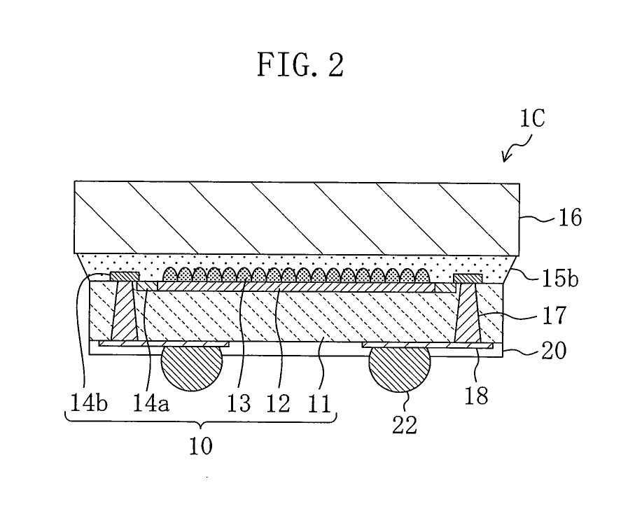

FIG. 2 is a cross-sectional view illustrating a structure of the solid-state imaging device of the second embodiment.

As illustrated in FIG. 2, the solid-state imaging device 1C of this embodiment is characterized in the shape of an adhesive member 15b between a solid-state imaging element 10 and a transparent board 16. Specifically, a feature of the solid-state imaging device 1C is that the contact area between the adhesive member 15b and the transparent board 16 is larger than that between the adhesive member 15b and the surface of the solid-state imaging element 10. The other part of the structure is the same as that of the solid-state imaging device 1A illustrated in FIG. 1A, and thus description thereof is not repeated in this embodiment.

The solid-state imaging device 1C of this embodiment has the following advantages as well as the advantages of the solid-state imaging device 1A of the first embodiment. Specifically, in an environment in which thermal stress is repeatedly applied, the structure in which the contact area between the adhesive member 15b and the transparent board 16 is larger than that between the adhesive member 15b and the surface of the solid-state imaging element 10 causes stress generation points of stress due to a difference in linear expansion coefficient between different types of materials and external stress to be focused on the edge of the contact region between the transparent board 16 and the adhesive member 15b. This reduces stress occurring at electrode portions 14b of a peripheral circuit region 14a and near through-hole electrodes 17, thereby preventing degradation of electrical characteristics and reliability. This structure is effective especially when the adhesive member 15b is thin as small as 50 μm or less.

The adhesive member 15b of the solid-state imaging device 1C of this embodiment illustrated in FIG. 2 may have a cavity over an imaging region 12, as in FIG. 1B.

### Embodiment 3

Hereinafter, a method for fabricating a solid-state imaging device according to a third embodiment of the present invention, specifically a method for fabricating the solid-state imaging devices 1A through 1C of the first and second embodiments described above will be described.

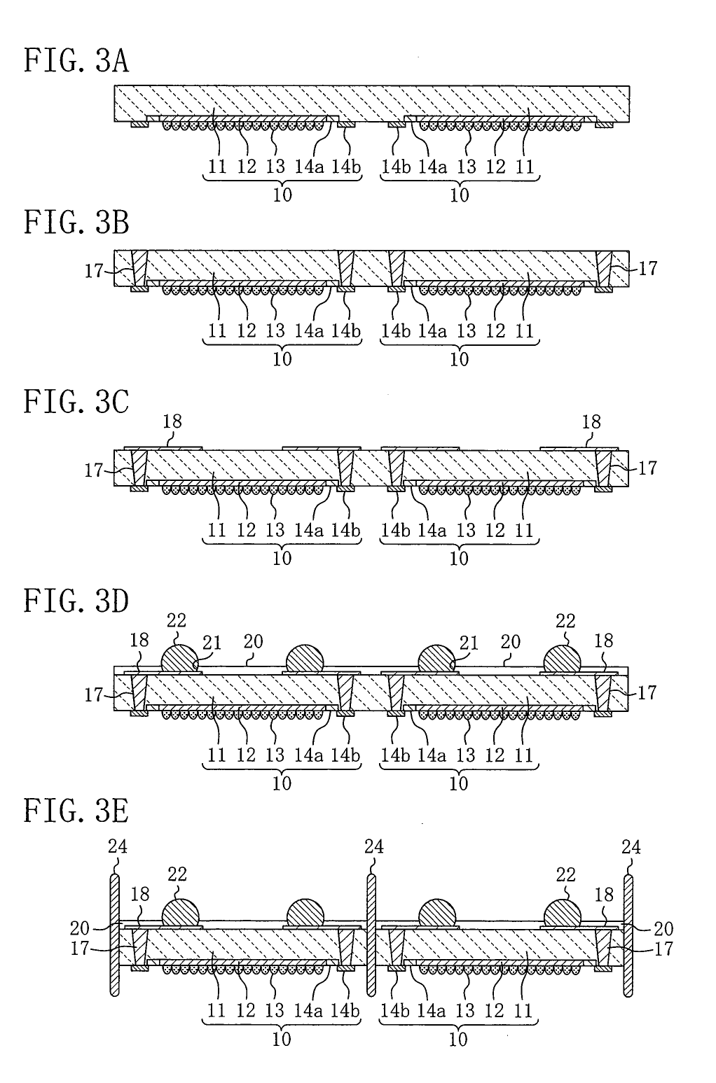

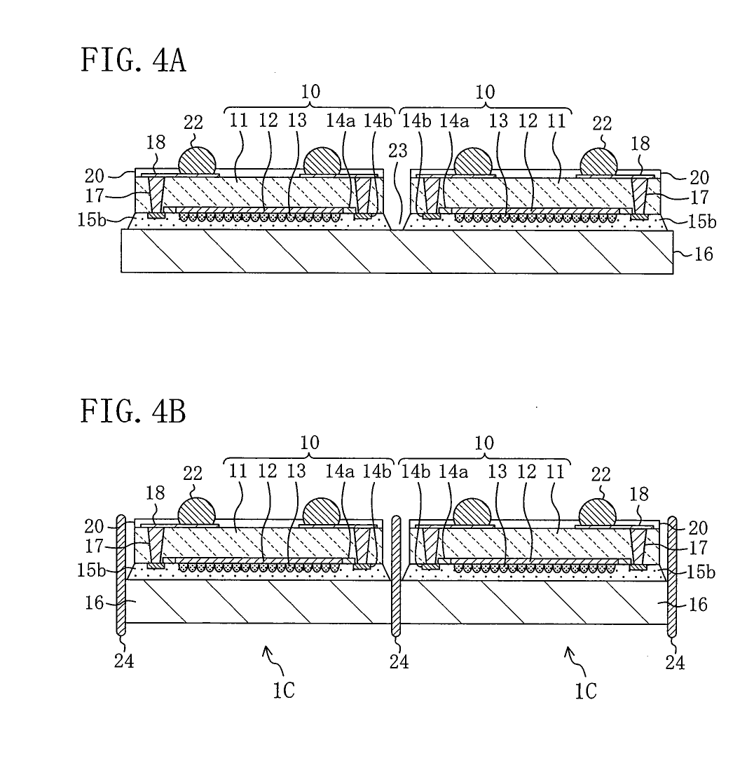

FIGS. 3A through 3E and FIGS. 4A and 4B are cross-sectional views showing process steps of a method for fabricating a semiconductor device according to the third embodiment in the order of fabrication steps. Specifically, a method for fabricating the solid-state imaging device 1C illustrated in FIG. 2 is exemplified.

First, as shown in FIG. 3A, a wafer formed with a known method and provided with a plurality of solid-state imaging elements 10 having the structure shown in FIGS. 1A and 1B and FIG. 2 is prepared. At this time, the wafer is back grinded to a desired thickness (which is generally 100 μm to 300 μm) and is subjected to mirror finishing such as CMP beforehand.

Next, as shown in FIG. 3B, through-hole electrodes 17 are formed from the back surface of the solid-state imaging elements 10 toward the back surface of electrode portions 14b for outputting a received light signal. Specifically, through holes which penetrate a semiconductor substrate 11 from the back surface thereof and in which the electrode portions 14b of a peripheral circuit region 14a are exposed are formed by, for example, dry etching or wet etching. Then, an insulating layer (not shown) is formed over the entire back surfaces of the solid-state imaging elements 10 and in the through holes with, for example, a CVD process or a printing and filling process of an insulating paste.

Subsequently, part of the insulating layer which is formed on the back surfaces of the electrode portions 14b in the through holes is removed by dry etching again. Then, a thin-film metal interconnect is formed by, for example, sputtering over the entire back surfaces of the solid-state imaging elements 10 and inside the through holes. The thin-film metal interconnect is usually made of Ti or Cu. Thereafter, the through holes are filled with a metal film by an electroplating process or a printing and filling process of a conductive paste, thereby forming through-hole electrodes 17. The inside of each of the through-hole electrodes 17 is not necessarily filled with metal.

Thereafter, metal interconnects 18 electrically connected to the through-hole electrodes 17 are formed by photolithography, electroplating and wet etching. Specifically, a photosensitive liquid resist is applied by spin coating or a dry film is attached to the entire back surfaces of the solid-state imaging elements 10. Then, the resist is patterned into the shape of the metal interconnects 18 with light exposure and development. The thickness of the resist is determined according to a desired final thickness of the metal interconnects 18 and is generally 10 μm to 30 μm. Subsequently, a metal interconnects 18 are formed by electroplating in the openings provided in the resist. Thereafter, the resist is removed and cleaning is performed.

Then, the thin-film metal interconnect which has been previously formed by sputtering at the formation of the through-hole electrodes 17 is removed by wet etching, thereby forming metal interconnects 18. The resist and dry film may be any of a negative type or a positive type. As the electroplating, Cu plating is usually employed. For wet etching of the thin-film metal interconnect, a hydrogen peroxide solution is usually used for Ti and ferric chloride is usually used for Cu. In the foregoing description, additive formation using electroplating is employed. Alternatively, a process in which electrolytic Cu plating is applied onto the entire back surfaces of the solid-state imaging elements 10 and then resist formation and wet etching are performed may be employed.

Thereafter, as shown in FIG. 3D, an insulating resin layer 20 is formed over the back surfaces of the solid-state imaging elements 10 to cover the metal interconnects 18. The insulating resin layer 20 is generally made of a photosensitive resin and formed by spin coating or attaching a dry film. Subsequently, the insulating resin layer 20 is selectively removed by photolithography (light exposure and development), thereby forming openings 21 in which the metal interconnects 18 are partly exposed. Thereafter, external electrodes 22 electrically connected to the metal interconnects 18 and made of, for example, a lead-free solder material with a Sn—Ag—Cu composition is formed by a solder ball mounting process using flux, a solder paste printing process or an electroplating process.

Then, as shown in FIG. 3E, the solid-state imaging elements 10 and the insulating resin layer 20 are cut into pieces of a plurality of solid-state imaging elements 10 with a cutting member 24 such as a dicing saw.

Subsequently, as shown in FIG. 4A, an adhesive member made of a resin layer is applied onto a transparent board 16 in the form of a wafer or a square plate having an area enough to mount a plurality of solid-state imaging elements 10 thereon. Then, individual pieces of solid-state imaging elements 10 are placed on the adhesive member at regular intervals (i.e., with spaces 23 left therebetween). At this time, control of the amount of the adhesive layer during application allows the shape of the adhesive member after bonding to the solid-state imaging elements 10 to be adjusted. Specifically, FIG. 4A shows the case of an adhesive member 15b having the shape shown in FIG. 2, but the adhesive member 15 having the shape shown in FIG. 1 may be used. In the case of the adhesive member 15b, the contact area between the adhesive member 15b and the transparent board 16 is larger than that between the adhesive member 15b and the surface of each of the solid-state imaging elements 10 as described in the second embodiment, and the advantages thereof are the same as those in the second embodiment. The adhesive member is not necessarily applied onto the transparent board 16 but may be applied onto the surfaces of the solid-state imaging elements 10. Control of the size of the spaces 23 allows the size of the resultant individual pieces of the transparent board 16 formed at the next process step to be flexibly determined. Since a plurality of solid-state imaging elements 10 are mounted on one transparent board 16, only non-defective elements are effectively used so that productivity is enhanced and fabrication cost is reduced.

Lastly, as shown in FIG. 4B, the transparent board 16 is cut into individual pieces of solid-state imaging devices 1C shown in FIG. 2 along the spaces 23 between the solid-state imaging elements 10 with a cutting member 24 such as a dicing saw. In this manner, only the transparent board 16 is cut along the spaces 23 without cutting the adhesive member 15. This prevents degradation of adhesion and peeling off of the adhesive member 15 and also prevents shortening of the life of a cutting member 24 such as a dicing saw. In addition, in the process of separating the solid-state imaging elements 10 into individual pieces, the cutting member 24 used in this process does not need to have a large width corresponding to the width of the cutting member 24 for cutting the transparent board 16. Accordingly, a large number of solid-state imaging elements 10 are obtained from one wafer, thus reducing the total fabrication cost.

FIGS. 3A through 3E show a fabrication method for a single wafer provided with a plurality of solid-state imaging elements 10. Alternatively, a supporting substrate may be attached to the surfaces of the solid-state imaging elements 10 as wafer reinforcements beforehand and then peeled off before the process step shown in FIG. 4A.

### Embodiment 4

Hereinafter, a solid-state imaging device according to a fourth embodiment of the present invention will be described.

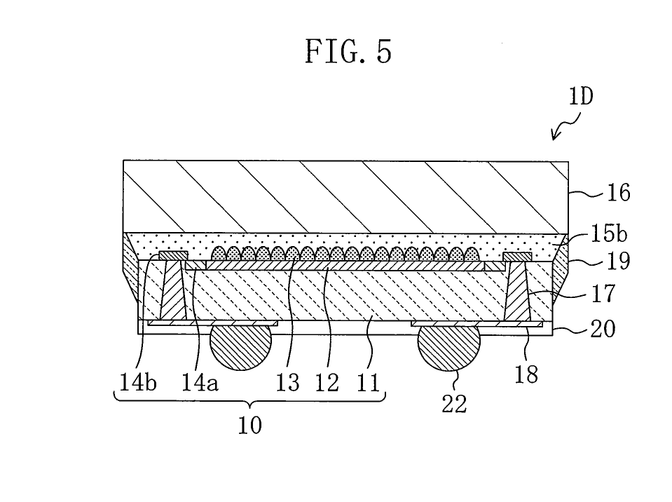

FIG. 5 is a cross-sectional view illustrating a structure of the solid-state imaging device of the fourth embodiment.

As illustrated in FIG. 5, the solid-state imaging device 1D of this embodiment is characterized by further including a resin layer 19 covering the periphery of an adhesive member 15b and part of the side face of a solid-state imaging element 10, in addition to the structure of the solid-state imaging device 1C of the second embodiment illustrated in FIG. 2. The resin layer 19 is a general thermosetting or UV-curing resin such as an epoxy resin or a photosensitive resin. A light-shielding resin having a light-shielding property is preferably used. The other part of the structure is the same as that of the solid-state imaging device 1C shown in FIG. 2 and description thereof is not repeated in this embodiment.

In addition to the advantages of the solid-state imaging devices 1A and 1C of the first and second embodiments, the solid-state imaging device 1D of this embodiment has the following advantages. The resin layer 19 increases the adhesive strength of the adhesive member 15b and prevents the adhesive member 15b from absorbing moisture, thereby enhancing reliability including heat resistance. In the case of using a light-shielding resin as the resin layer 19, deterioration of image properties caused by incident light from the side face of the transparent board 16 is further suppressed.

The adhesive member 15b of the solid-state imaging device 1D of this embodiment shown in FIG. 5 may have a cavity over an imaging region 12 as in FIG. 1B.

### Embodiment 5

Hereinafter, a method for fabricating a solid-state imaging device according to a fifth embodiment of the present invention, specifically a method for fabricating the solid-state imaging device 1D described in the fourth embodiment will be described.

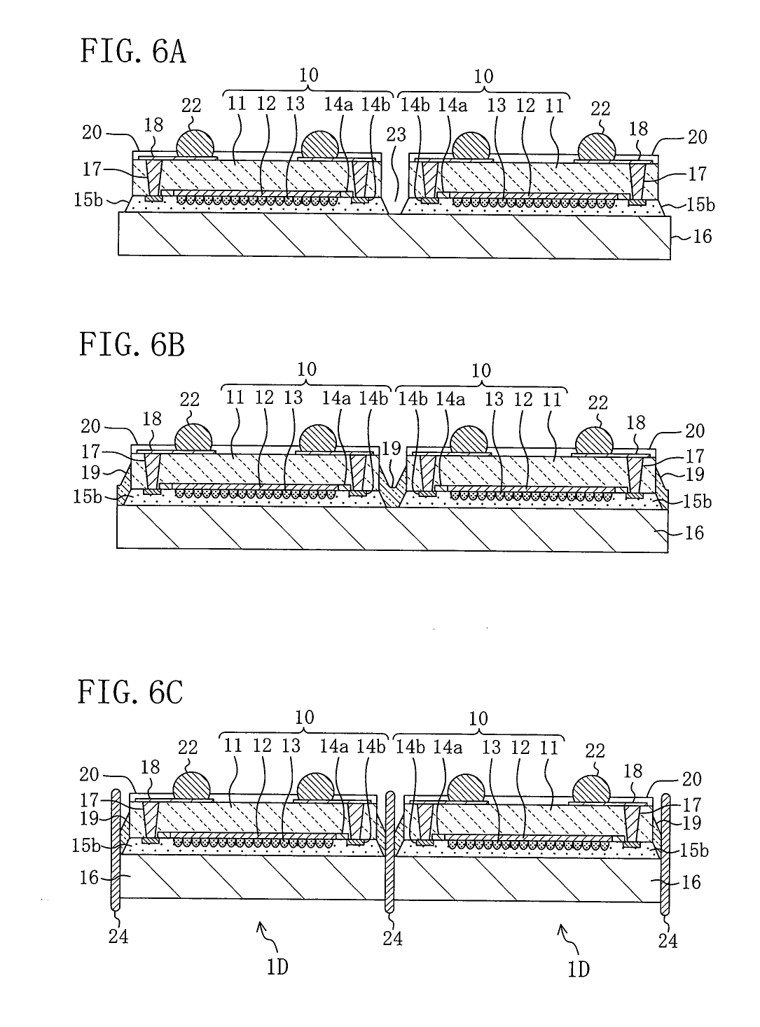

FIGS. 6A through 6C are cross-sectional views showing a method for fabricating the solid-state imaging device according to the fifth embodiment in the order of fabrication steps.

The method for fabricating a solid-state imaging device of the fifth embodiment is characterized in fabrication process steps associated with characteristics of the structure of the solid-state imaging device 1D of the fourth embodiment. Thus, description will be given mainly on process steps for fabricating the characteristic parts. The other process steps are the same as those described in the third embodiment, and thus description thereof is not repeated in this embodiment.

First, process steps which are the same as those described with reference to FIGS. 3A through 3E and FIG. 4A are performed to obtain a structure shown in FIG. 6A, which is the same as that shown in FIG. 4A.

Next, as shown in FIG. 6B, a resin layer 19 is applied onto spaces 23 and then is cured.

Lastly, as shown in FIG. 6C, the resin layer 19 and a transparent board 16 are cut into individual pieces of solid-state imaging devices 1D shown in FIG. 5 along the space 23 between solid-state imaging elements 10 with a cutting member 24 such as a dicing saw. The resin layer 19 is made of a general thermosetting or UV-curing resin such as an epoxy resin or a photosensitive resin. A light-shielding resin having a light-shielding property is preferably used. Control of the amount of the resin layer 19 during application in the process step shown in FIG. 6B allows the area of the resin layer 19 covering the side faces of the solid-state imaging elements 10 to be adjusted. The resin layer 19 preferably covers at least the periphery of an adhesive member 15b. The advantages obtained by covering the periphery of the adhesive member 15b with the resin layer 19 are already described in the fourth embodiment. In this embodiment, the same structure as that in the third embodiment has the same advantages.

### Embodiment 6

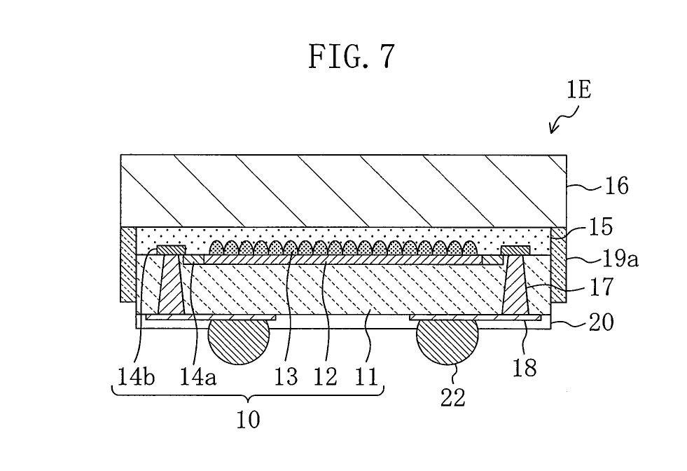

FIG. 7 is a cross-sectional view illustrating a structure of a solid-state imaging device according to a sixth embodiment of the present invention.

As illustrated in FIG. 7, the solid-state imaging device of this embodiment is characterized by further including a resin layer 19a covering the periphery of an adhesive member 15 and part of the side face of a solid-state imaging element 10, in addition to the structure of the solid-state imaging device 1A of the first embodiment illustrated in FIG. 1A. The resin layer 19a is made of the same material as that described in the fourth embodiment. The other part of the structure is the same as that of the solid-state imaging device 1A illustrated in FIG. 1A, and thus description thereof is not repeated in this embodiment.

The solid-state imaging device 1E of this embodiment has advantages which are the same as those of the solid-state imaging device 1D of the fourth embodiment as well as the advantages of the solid-state imaging device 1A of the first embodiment. As in FIG. 1B, the adhesive member 15 of the solid-state imaging device 1E of this embodiment illustrated in FIG. 7 may have a cavity over an imaging region 12.

### Embodiment 7

Hereinafter, a method for fabricating a solid-state imaging device according to a seventh embodiment of the present invention, specifically a method for fabricating a solid-state imaging device 1E described in the sixth embodiment, will be described.

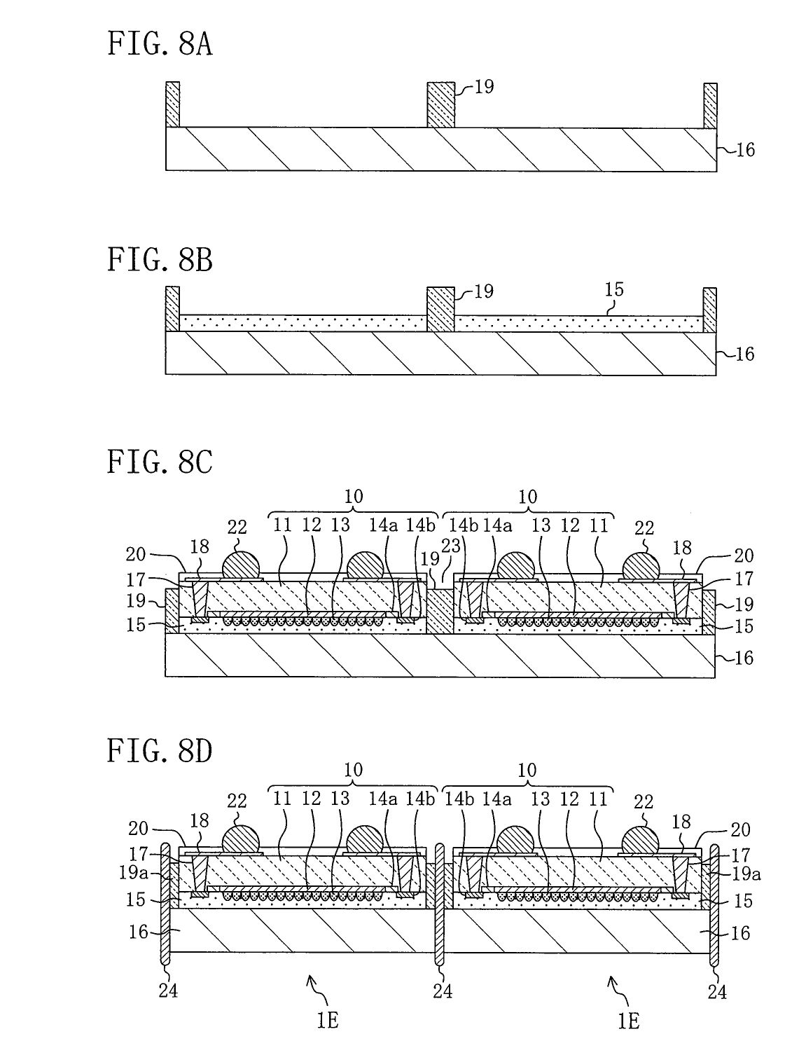

FIGS. 8A through 8D are cross-sectional views showing a method for fabricating the solid-state imaging device of the seventh embodiment in the order of fabrication.

The method for fabricating a solid-state imaging device of the seventh embodiment is characterized in fabrication process steps associated with characteristics of the structure of the solid-state imaging device 1E of the sixth embodiment. Thus, description will be given mainly on process steps for fabricating the characteristic parts. The other process steps are the same as those described in the third embodiment, and thus description thereof is not repeated in this embodiment.

First, process steps already described with reference to FIGS. 3A through 3E are performed.

On the other hand, as shown in FIG. 8A, a resin layer 19 is previously applied and formed onto a transparent board 16 in the form of a wafer or a square plate. At this time, the resin layer 19 is formed in such a manner that the position of the resin layer 19 coincides with spaces 23 located between adjacent solid-state imaging elements 10 in a subsequent process step of mounting solid-state imaging elements 10. Then, an adhesive member 15 made of a resin layer is applied onto a region of the transparent board 16 on which solid-state imaging elements 10 are to be mounted and which is surrounded by the resin layer 19.

Next, as shown in FIG. 8C, solid-state imaging elements 10 are mounted on the transparent board 16 with an adhesive member interposed therebetween.

Lastly, as shown in FIG. 8D, the resin layer 19 and the transparent board 16 are cut into individual pieces of solid-state imaging devices 1E illustrated in FIG. 7 along the spaces 23 between the solid-state imaging elements 10 with a cutting member 24 such as a dicing saw. The resin layer 19 is made of a general thermosetting or UV-curing resin such as an epoxy resin or a photosensitive resin. A light-shielding resin having a light-shielding property is preferably used. With this method, the resin layer 19 is formed to have a cavity structure on the transparent board 16, thereby forming a region onto which the adhesive member 15 is to be applied. Thus, the amount of the adhesive member 15 during application is easily controlled. Accordingly, it is possible to prevent the adhesive member 15 from filling the spaces 23 between the solid-state imaging elements 10 owing to erroneous control of the amount of the adhesive member 15 during application. This prevents deterioration of the adhesive strength of the adhesive member and peeling off thereof caused by cutting the adhesive member and the transparent board 16 together into individual pieces. The advantages obtained by covering the periphery of the adhesive member 15 with the resin layer 19 are also described in the fourth embodiment. In this embodiment, part of the structure equivalent to that in the third embodiment has the same advantages.

In the foregoing description of the background of the invention and the embodiments, solid-state imaging devices are used as examples. However, the foregoing description is, of course, applicable to optical devices such as photo ICs, photo diodes and laser modules.

The optical devices according to the present invention have CSP structures with excellent optical properties. Thus, image sensors and other devices utilizing such optical devices are preferable in terms of miniaturization, thickness reduction and functional enhancement of digital optical equipment such as digital still cameras, cameras for cellular phones and video cameras. These image sensors and other devices are also used for medical equipment and are widely applicable to various equipment and apparatus having digital video and image processing function.

What is claimed is:

1. An optical device, comprising:
an optical element including an imaging region formed on a principal surface of a semiconductor substrate, a peripheral circuit region formed at a rim of the imaging region and including a plurality of electrode portions, and a plurality of microlenses formed on the imaging region;
a plurality of through-hole electrodes connected to the respective electrode portions and formed through the semiconductor substrate along the thickness of the semiconductor substrate;
a plurality of metal interconnects connected to the respective through-hole electrodes and formed on a back surface of the semiconductor substrate opposite to the principal surface of the semiconductor substrate;
an adhesive member formed on a surface of the optical element and made of a resin; and
a transparent board bonded to the optical element with the adhesive member interposed therebetween,
wherein the transparent board has a planar shape larger than that of the optical element.

2. The optical device of claim 1, further comprising a resin layer covering a side face of the adhesive member.

3. The optical device of claim 1, wherein the adhesive member is formed over the entire surface of the optical device.

4. The optical device of claim 1, wherein the adhesive member is selectively formed only on a region of the surface of the optical element where the microlenses are formed.

5. The optical device of claim 1, wherein a contact area between the transparent board and the adhesive member is larger than a contact area between the surface of the optical element and the adhesive member.

6. The optical device of claim 5, wherein the adhesive member has a thickness of 50 μm or less.

7. The optical device of claim 1, further comprising:
an insulating resin layer formed on a back surface of the optical element to cover the metal interconnects and having openings in which the metal interconnects are partly exposed; and
external electrodes formed in the respective openings and connected to the metal interconnects.

8. A method for fabricating optical devices, the method comprising the steps of:
preparing an assembly provided with a plurality of optical elements, each of the optical elements including an imaging region formed on a principal surface of a semiconductor substrate, a peripheral circuit region formed at a rim of the imaging region and including a plurality of electrode portions, and a plurality of microlenses formed on the imaging region;
forming a plurality of through-hole electrodes connected to the respective electrode portions and formed through the semiconductor substrate along the thickness of the semiconductor substrate;
forming a plurality of metal interconnects in contact with the respective through-hole electrodes and formed on a back surface of the semiconductor substrate opposite to the principal surface of the semiconductor substrate;
cutting the assembly into a plurality of pieces corresponding to the respective optical elements, after the step of forming the metal interconnects;
bonding a surface of each of the optical elements and the transparent board together with an adhesive member of a resin interposed therebetween in such a manner that the resultant optical elements are spaced apart from each other; and
separating the transparent board into pieces along the space between the optical elements.

9. The method of claim 8, further comprising the step of forming a resin layer in the space between the optical elements on the transparent board, after the step of bonding the surface of each of the optical elements and the transparent board together,
wherein in the step of separating the transparent board, the resin layer and the transparent board are formed into pieces along the space between the optical elements.

10. The method of claim 8, wherein in the step of separating the transparent board, the transparent board has a planar shape larger than that of each of the optical elements.

11. The method of claim 8, wherein the adhesive member is formed over the entire surfaces of the optical elements.

12. The method of claim 8, wherein the adhesive member is selectively formed only on a region of the surface of each of the optical elements except for a region where the microlenses are formed.

13. The method of claim 8, wherein a contact area between the transparent board and the adhesive member is larger than a contact area between the surface of each of the optical elements and the adhesive member.

14. The method of claim 13, wherein the adhesive member has a thickness of 50 μm or less.

15. The method of claim 8, further comprising the steps of:
forming an insulating resin layer on back surfaces of the optical elements, the insulating resin layer covering the metal interconnects and having openings in which the metal interconnects are partly exposed; and
forming external electrodes in the respective openings, the external electrodes being connected to the metal interconnects,
wherein the step of forming the insulating resin layer and the step of forming the external electrodes are performed after the step of forming the metal interconnects.

16. A method for fabricating optical devices, the method comprising the steps of:
preparing an assembly provided with a plurality of optical elements, each of the optical elements including an imaging region formed on a principal surface of a semiconductor substrate, a peripheral circuit region formed at a rim of the imaging region and including a plurality of electrode portions, and a plurality of microlenses formed on the imaging region;
forming a plurality of through-hole electrodes connected to the respective electrode portions and formed through the semiconductor substrate along the thickness of the semiconductor substrate;
forming a plurality of metal interconnects in contact with the respective through-hole electrodes and formed on a back surface of the semiconductor substrate opposite to the principal surface of the semiconductor substrate;
cutting the assembly into a plurality of pieces corresponding to the respective optical elements, after the step of forming the metal interconnects;
forming a resin layer on the transparent board, the resin layer selectively having a plurality of openings;
bonding a surface of each of the optical elements and the transparent board together with an adhesive member of a resin interposed therebetween in such a manner that the resultant optical elements are spaced apart from each other; and
separating the resin layer and the transparent board into pieces along the space between the optical elements.

17. The method of claim 16, wherein in the step of separating the transparent board, the transparent board has a planar shape larger than that of each of the optical elements.

18. The method of claim 16, wherein the adhesive member is formed over the entire surfaces of the optical elements.

19. The method of claim 16, wherein the adhesive member is selectively formed only on a region of the surface of each of the optical elements except for a region where the microlenses are formed.

20. The method of claim 16, wherein a contact area between the transparent board and the adhesive member is larger than a contact area between the surface of each of the optical elements and the adhesive member.

21. The method of claim 20, wherein the adhesive member has a thickness of 50 μm or less.

22. The method of claim 16, further comprising the steps of:
forming an insulating resin layer on back surfaces of the optical elements, the insulating resin layer covering the metal interconnects and having openings in which the metal interconnects are partly exposed; and
forming external electrodes in the respective openings, the external electrodes being connected to the metal interconnects,
wherein the step of forming the insulating resin layer and the step of forming the external electrodes are performed after the step of forming the metal interconnects.
